(19) United States
(12) Patent Application Publication
(10) Pub. No.: US 2011/0194488 A1
(43) Pub. Date: Aug. 11, 2011

(54) Telephone System

(76) Inventors: Fang-Wen Kuo, Taipei Hsien (TW); Po-Hsu Chen, Taipei Hsien (TW)

(21) Appl. No.: 12/960,551

(22) Filed: Dec. 6, 2010

(30) Foreign Application Priority Data
Feb. 9, 2010 (TW) 099103925

(51) Int. Cl. H04L 12/66

(52) U.S. Cl. 370/328

(57) ABSTRACT

The present invention discloses a telephone system, for establishing a connection of Internet Protocol (IP) phone with a destination via Internet, comprises a television (TV) set and a smart phone device. The smart phone device transmits a voice signal generated by a microphone and an image signal generated by a camera via a wireless transceiver module, to another wireless transceiver module of the TV set. The TV set transfers the voice signal and the image signal to the destination and outputs a communication content of the destination via a monitor or a speaker.

### BACKGROUND OF THE INVENTION

1. Field of the Invention

The present invention relates to a telephone system, and more particularly, to a telephone system for realizing Internet Protocol (IP) phone via a television (TV) set capable of connecting to a broadband Internet, and solving issues of sounds receiving or image capturing via a smart phone device.

2. Description of the Prior Art

With the continuous development of network communication technology and the popularization of network linking, interpersonal communication is more and more convenient, and gradually moves towards digital voice communication. Digital voice communication techniques can provide high quality of sounds. More importantly, because a bandwidth of Internet is wider than that of a traditional public switched telephone network (PSTN), digital voice communication techniques provides not only real-time voice communication services but also services of exchanging images or files. In addition, communication fees via Internet, especially for long-distance or international calls, are much less than fees via the traditional telephone system.

Hence, communications via Internet can provide high-quality services of exchanging voices, images, etc., and more importantly, the low communication fees and high popularization rates of Internet can save costs of communications for industries or individuals. However, since digital voice communication is established under Internet, except using a computer system to realize Internet Protocol (IP) phone (or Web Phone), the user has to purchase a new IP phone device, which results in an additional cost.

Therefore, how to realize IP phone by utilizing domestic equipments becomes one of the targets in the industry.

### SUMMARY OF THE INVENTION

It is an objective of the claimed invention to provide a telephone system.

The present invention provides a telephone system, for establishing a connection of Internet Protocol (IP) phone with a destination via Internet, which comprises a television (TV) set and a smart phone device. The TV set comprises a monitor, a speaker, a signal processing module, for receiving an external audio and video (A/V) signal and demonstrating a multimedia content of the external A/V signal via the monitor and the speaker, a first wireless transceiver module, for performing wireless transmission, and a web phone module, coupled to the signal processing module and the first wireless transceiver module, for receiving a voice signal via the first wireless transceiver module, transferring the voice signal to the destination, and transmitting a communication content of the destination to the signal processing module, to output the communication content via the monitor or the speaker. The smart phone device comprises a microphone, for receiving sounds to generate the voice signal, a second wireless transceiver module, for performing wireless transmission, and a control unit, coupled to the microphone and the second wireless transceiver module, for transmitting the voice signal received by the microphone to the first wireless transceiver module via the second wireless transceiver module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a telephone system according to an embodiment of the present invention.

FIG. 1B is a function block diagram of the telephone system shown in FIG. 1A.

FIG. 2A to FIG. 2E are schematic diagrams when the telephone system shown in FIG. 1A performs Internet Protocol (IP) phone operation in different modes.

FIG. 3A and FIG. 3B are schematic diagrams when the telephone system shown in FIG. 1A demonstrates TV programs and image phone by picture on picture and picture in picture.

### DETAILED DESCRIPTION

As multimedia techniques advance, except for showing programs received from an antenna or a cable, a television (TV) set can further include Internet communication functions, to obtain information and digital contents from Internet. In other words, the TV set can directly connect to a broadband network and demonstrate digital contents, without a personal computer or a set-top box. The present invention is to realize Internet Protocol (IP) phone, or namely web phone, via the TV set capable of connecting to a broadband network, and to improve a sound receiving problem by connecting to a smart phone device. In short, if a conventional TV set capable of connecting to a broadband network is utilized for realizing IP phone, one of the design issues is how to set a microphone. If a microphone is installed on a housing of the TV set, the microphone cannot obtain sounds well because a user usually keeps a distance of about 3 meters away from the TV set when watching TV. However, if an external microphone is connected with the TV set via a signal extended line, inconvenience occurs. Hence, in order to improve the issue of installing the microphone, the present invention applies a network linking function and a high-quality sound reception capability of a smart phone device to a TV set capable of connecting to Internet, to realize household web phone.

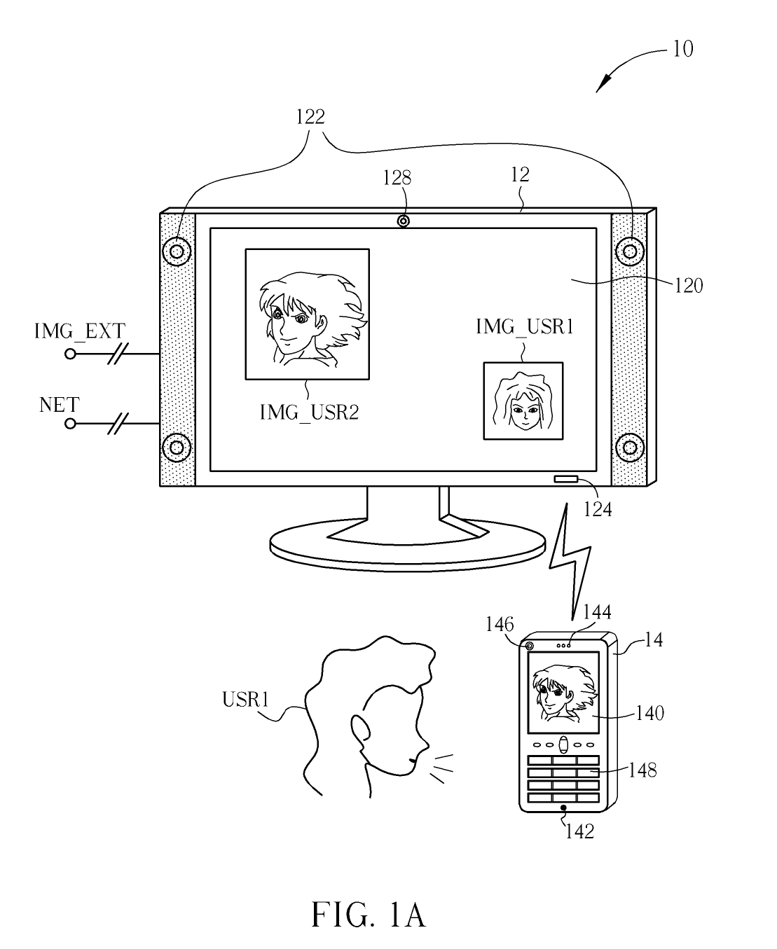

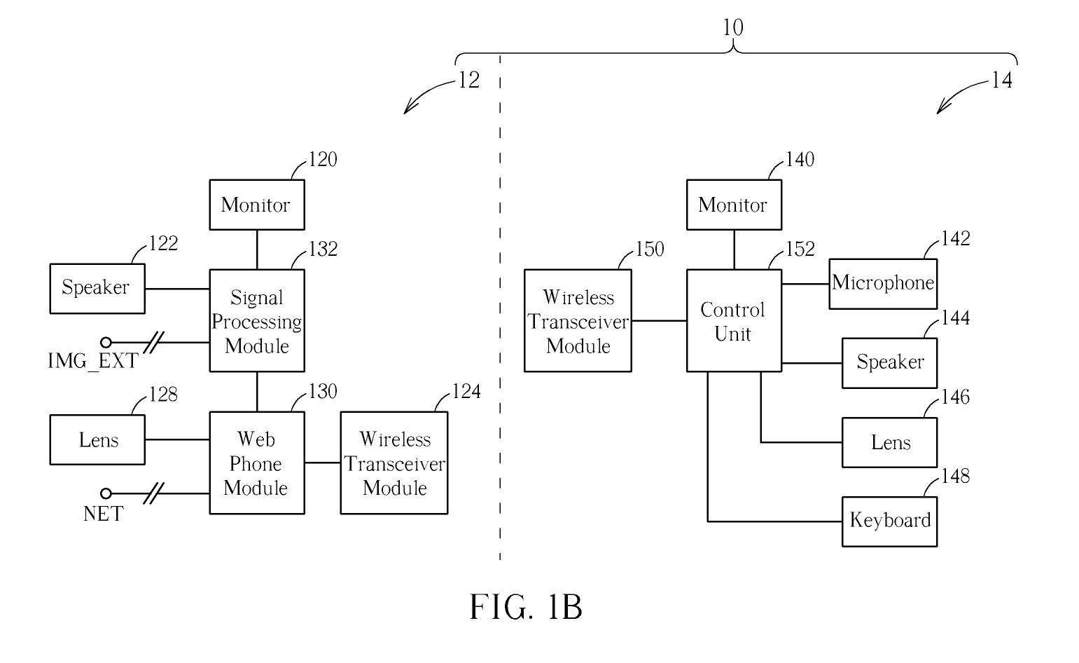

Please refer to FIG. 1A and FIG. 1B. FIG. 1A is a schematic diagram of a telephone system 10 according to an embodiment of the present invention, and FIG. 1B is a functional block diagram of the telephone system 10. As shown in FIG. 1A and FIG. 1B, the telephone system 10 comprises a TV set 12 and a smart phone device 14. The TV set 12 comprises a monitor 120, a speaker 122, a wireless transceiver module 124, a lens 128, a web phone module 130, and a signal processing module 132. The smart phone device 14 comprises a monitor 140, a microphone 142, a speaker 144, a lens 146, a keyboard 148, a wireless transceiver module 150, and a control unit 152. In the TV set 12, the signal processing module 132 can receive an external audio and video (A/V) signal IMG_EXT, such as a TV broadcasting signal, an A/V player signal, etc., and output multimedia contents via the monitor 120 and the speaker 122. The web phone module 130 can connect to Internet NET, and realize a web phone function with the smart phone device 14. In such a way, a user USER1 can perform video phone with a destination via Internet, such that the user USER1 and the destination can observe images IMG_USER1 and IMG_USER2 of each other. In short, the monitor 120, the speaker 122, and the signal processing module 132 are the necessary devices of a traditional TV set, whose operating principles are well known for those skilled in the art. As to how the telephone system 10 performs IP phone, please refer to the following descriptions in coordination with figures, illustrating operations and output statuses of the components under different modes.

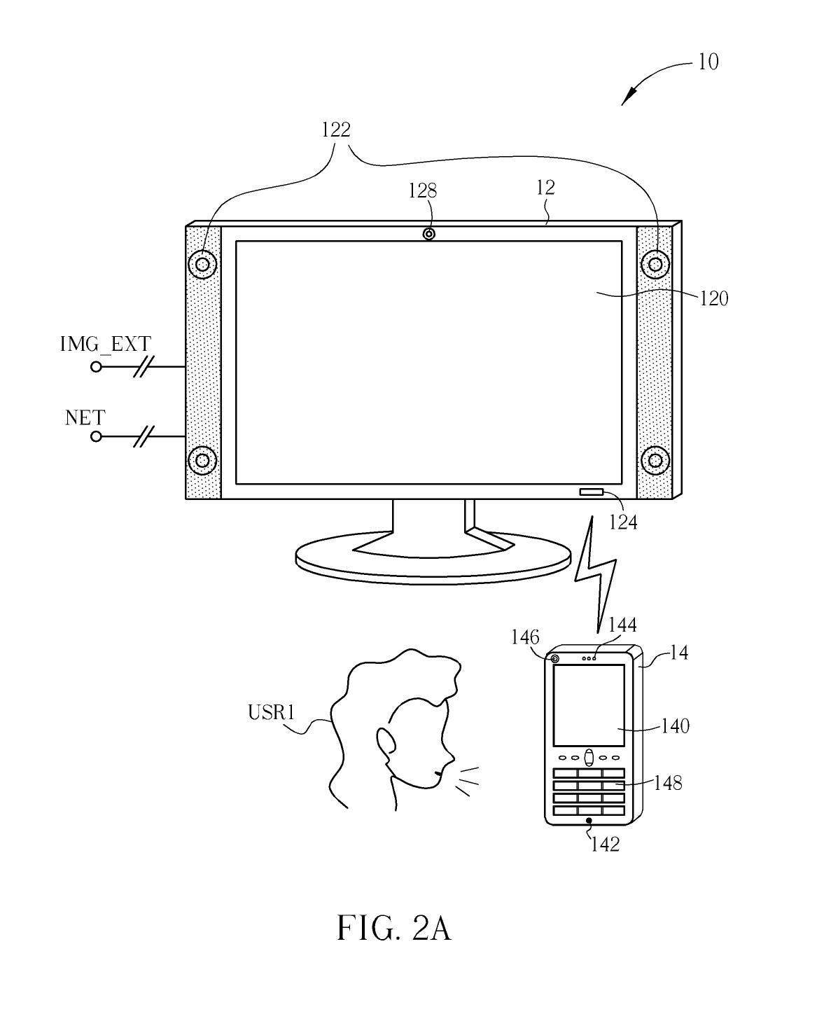

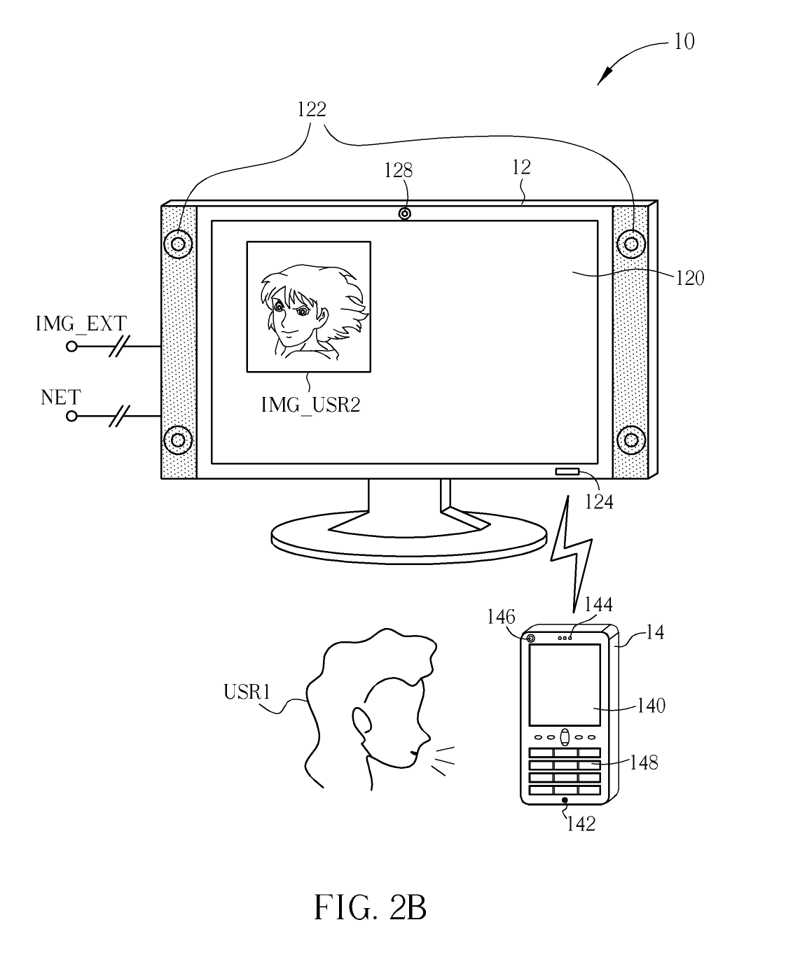

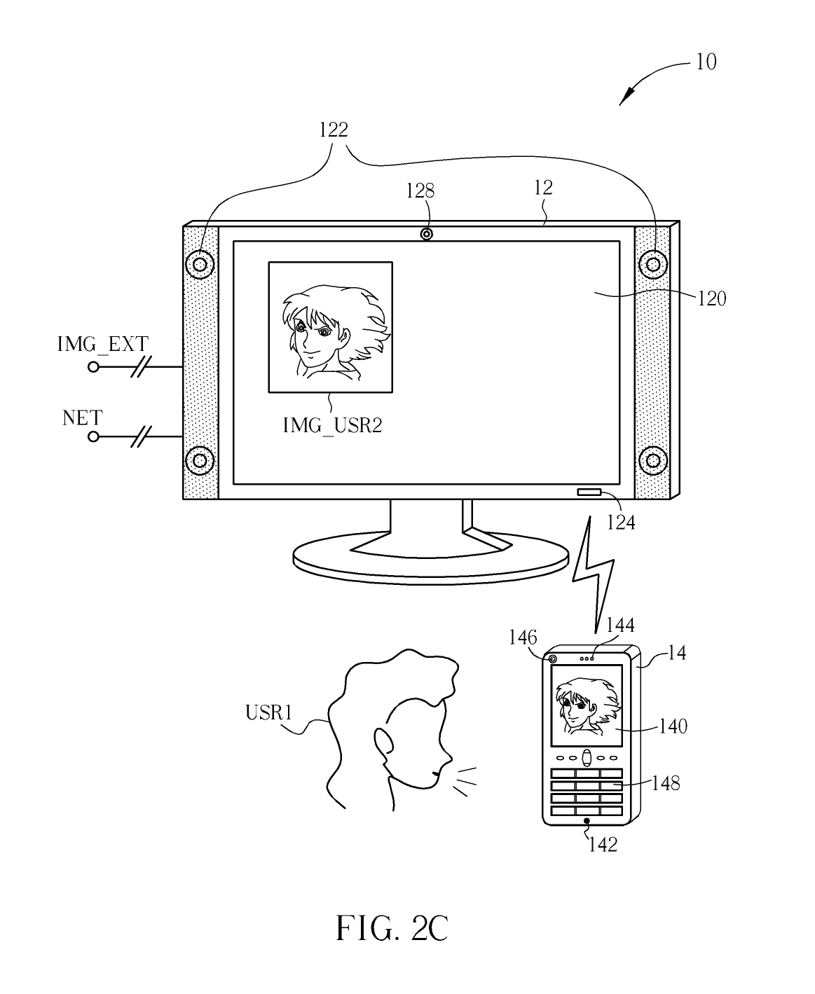

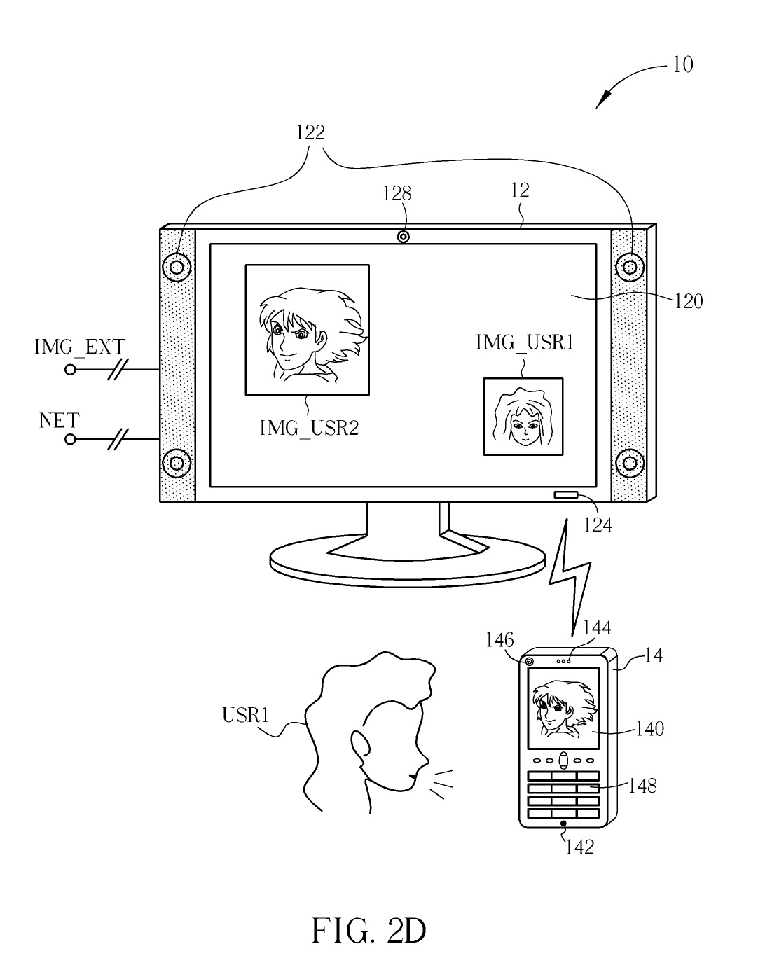

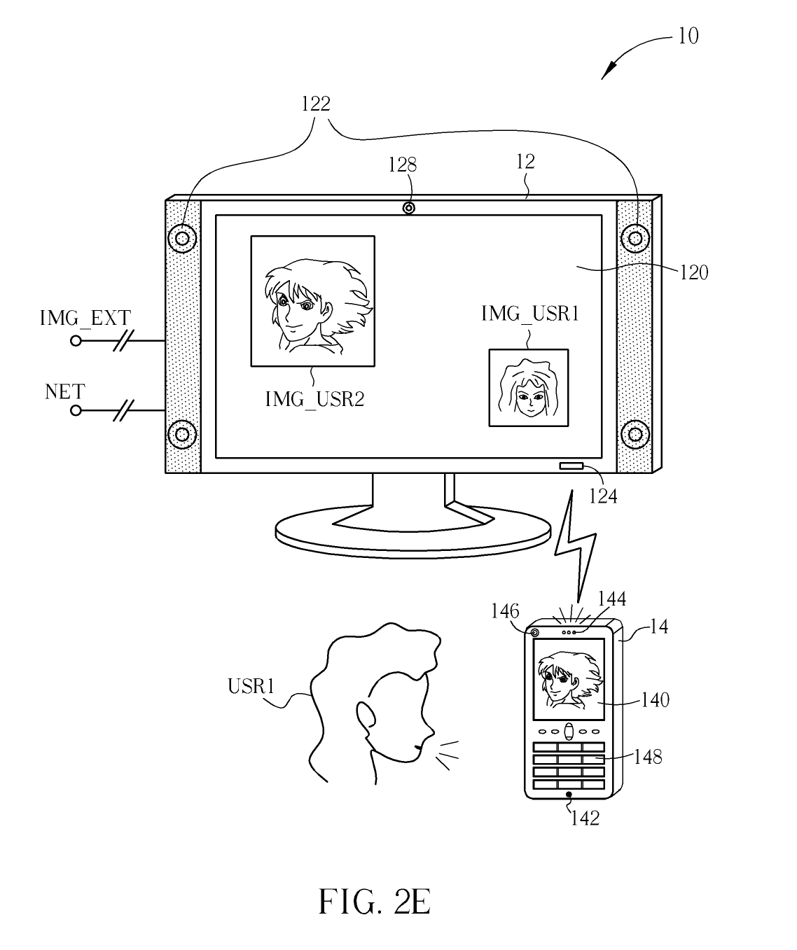

First, as shown in FIG. 2A, the telephone system 10 receives a voice of the user USER1 via the microphone 142 of the smart phone device 14, and outputs a voice of the destination via the speaker 122 of the TV set 12. In other words, the monitor 120 of the TV set 12 and the monitor 140 of the smart phone device 14 both do not demonstrate any images (in some cases, the monitors 120 and 140 can demonstrate specific images, and the details are narrated hereafter), and wireless signals outputted from the smart device 14 to the TV set 12 are the voice received by the microphone 142. In detail, when operating in this mode, the voice received by the microphone 142 is first transmitted to the control unit 152, and then wirelessly transmitted to the wireless transceiver module 124 via the wireless transceiver module 150. After the wireless transceiver module 124 receives the voice signal of the user USER1, the web phone module 130 transmits the voice signal to the destination via the Internet NET. Accordingly, the web phone module 130 receives the voice signal of the destination via the Internet NET, and drive the speaker 122 to generate the corresponding sounds via the signal processing module 132.

Therefore, the example of FIG. 2A can be regarded as a basic IP phone function of the telephone system 10, i.e. voice communication function, without exchanging images. Meanwhile, in this example, the lens 128 of the TV set 12 and the lens 146 of the smart phone device 14 both do not capture images. In other words, the example can be further derived and applied to TV sets and smart phone devices without lens equipped. That is to say, the purpose of the present invention is to obtain the voice signal of the user USER1 via the microphone 142 of the smart phone device 14, to achieve IP phone, such that even if the TV set 12 and the smart phone device 14 are not equipped with the lenses 128 and 146, or the lenses 128 and 146 are malfunctioned, or the communication contents of the destination only comprise a voice component, the concept of the present invention still works. Under such a condition, the mode of FIG. 2A can be set as a power saving mode, which achieves IP phone via the TV set 12 and the smart phone device 14 with the lowest power consumption. In addition, in this mode, the monitor 120 can further be utilized for demonstrating TV programs, predefined background images, photos, such as a photo of a caller.

Continued with the example of FIG. 2A, if the monitor 120 of the TV set 12 has been turned on, and the web phone module 130 has received an image signal of the destination, i.e. the communication contents of the destination includes both image and voice components, then the image IMG_USR2 can be shown by the monitor 120 as shown in FIG. 2B, or at same time, shown by the monitor 140 through transmitting the corresponding image signal to the smart phone device 14, as shown in FIG. 2C. That is to say, in the mode of FIG. 2B, in addition to transmitting the voice signal as shown in FIG. 2A, the web phone module 130 further receives the image signal of the destination via the Internet NET, and the signal processing module 132 triggers the monitor 120 to show the corresponding image IMG_USR2. Moreover, the web phone module 130 can transmit the image signal of the destination to the wireless transceiver module 150 via the wireless transceiver module 124, such that the control unit 152 drives the monitor 140 to show the image IMG_USR2 simultaneously, as shown in FIG. 2C.

In FIG. 2B and FIG. 2C, the telephone system 10 receives the image signal of the destination, such that the image IMG_SUR2 can be displayed via the monitor 120, or simultaneously displayed via the monitor 140. This mode can be resulted from the following three applications: 1. the TV set 12 and the smart phone device 14 do not include the lenses 128 and 146; 2. both the lenses 128 and 146 are not triggered; 3. the lenses 128 and 146 function normally but the image IMG_USR1 of the user USER1 are not shown via the monitor 120 or 140.

If the lenses 128 and 146 operate normally, the image IMG_USR1 of the user USR1 can further be shown on the monitor 120 or 140, and the display method thereof has no restriction. For example, in FIG. 2D, the monitors 120 and 140 both demonstrate the images IMG_USR1 and IMG_USR2 simultaneously. In FIG. 2E, the monitor 120 demonstrates the images IMG_USR1 and IMG_USR2 simultaneously, while the monitor 140 only demonstrates the image IMG_USR2. By the same token, the monitor 120 can show the images IMG_USR1 and IMG_USR2, while the monitor 140 shows only the image IMG_USR1. Alternatively, the monitor 120 shows the image IMG_USR2, and the monitor 140 shows the image IMG_USR1.

In addition to outputting the voice of the destination via the speaker 122, there are other ways to output the voice. For example, the web phone module 130 can transmit the voice signal of the destination to the smart phone device 14, and the control unit 152 drives the speaker 144 to emit the voice of the destination. Meanwhile, the various embodiments described above can be combined with each other according to design requirements.

Note that, regardless of adopting any of the above examples to perform IP phone, the web phone module 130 uses the wireless communication method to obtain the voice signal of the user USR1 via the smart phone device 14. Under such circumstances, the TV set 12 does not need to include a microphone. Meanwhile, since the microphone 142 of the smart phone device 14 usually has good performance on receiving sounds, the user USR1 can put the smart phone device 14 on a table, and face the TV set 12 to perform video phone. Certainly, the user USR1 can further pick up the smart phone device 14, as make a traditional phone call (i.e. the voice of the destination is only outputted by the smart phone device 14), to perform IP phone.

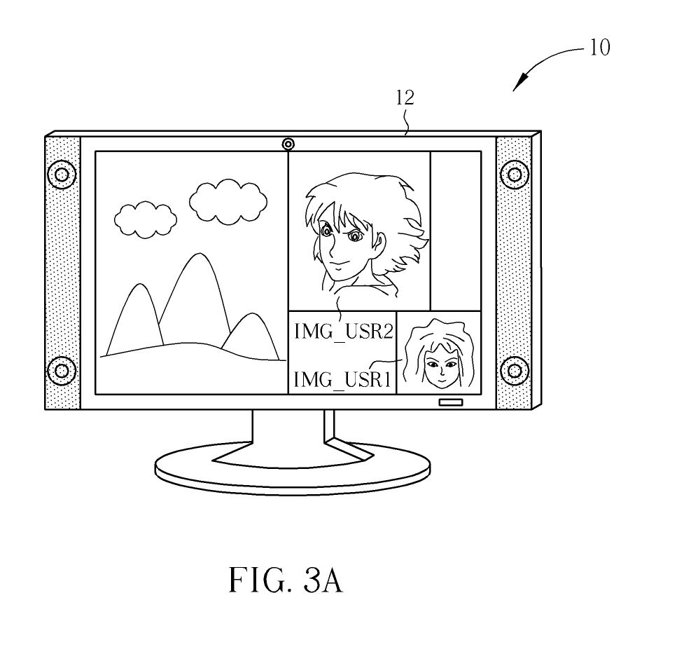

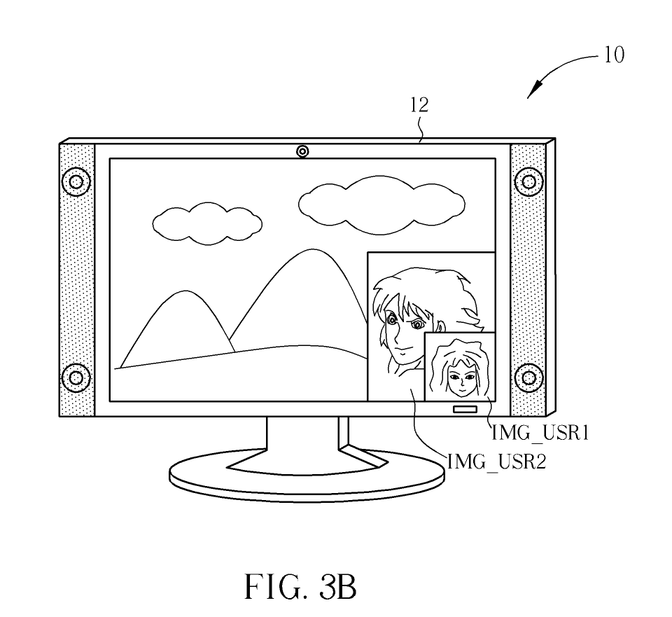

In addition, to prevent an on-going video phone from affecting a TV program or a multimedia content shown on the TV set 12, the signal processing module 132 can further perform various display methods, such as picture on picture (POP) shown in FIG. 3A, picture in picture (PIP) shown in FIG. 3B, etc. FIG. 3A and FIG. 3B are exemplary embodiments of the present invention, and those skilled in the art can make different modifications accordingly. For example, a ratio of the TV program to the video phone on the screen can be changed according to different requirements, so as to achieve a display method of picture and picture (P&P). Also, the contents of the video phone can include both of the images IMG_USR1 and IMG_USR2, or one of them. In addition, an indicating mechanism can be included to show a small window for indicating an incoming call on the monitors 120 and 140. When the user accepts the call, the system mutes the external A/V signal IMG_EXT automatically, and switches to output the voice of the destination. When the call is completed, the system switches to output the external A/V signal IMG_EXT automatically. Certainly, when the TV set performs video phone, images shown by the monitors 120 and 140 can also be switched by the same operating principle.

Furthermore, when the user USR1 needs to dial a telephone number, the user USR1 can achieve the action via the keyboard 148 of the smart phone device 14. In such a situation, signals transmitted from the wireless transceiver module 150 to the wireless transceiver module 124 are no longer voice or image signals of the user USR1, but comprises commands or signals corresponding to the telephone number.

A user usually keeps a distance of about 3 meters away from a TV set when watching TV, which results in a bad effect of receiving sounds via a microphone set on the housing of the TV set. For improving the microphone setting issue, the present invention applies the network linking function and the high-quality sound reception capability of the smart phone device to the TV set capable of connecting to Internet, such that the user can put the smart phone device on a table, and face the TV set to perform video phone, or pick up the smart phone device as make a traditional phone call to perform web phone. Hence, the present invention can effectively improve the sound receiving issue of the microphone, so as to promote users to adopt web phone.

Those skilled in the art will readily observe that numerous modifications and alterations of the device and method may be made while retaining the teachings of the invention.

What is claimed is:

1. A telephone system, for establishing a connection of Internet Protocol (IP) phone with a destination via Internet, comprising:
a television (TV) set, comprising:
a monitor;
a speaker;
a signal processing module, for receiving an external audio and video (A/V) signal and demonstrating a multimedia content of the external A/V signal via the monitor and the speaker;
a first wireless transceiver module, for performing wireless transmission; and
a web phone module, coupled to the signal processing module and the first wireless transceiver module, for receiving a voice signal via the first wireless transceiver module, transferring the voice signal to the destination, and transmitting a communication content of the destination to the signal processing module, to output the communication content via the monitor or the speaker; and
a smart phone device, comprising:
a microphone, for receiving sounds to generate the voice signal;
a second wireless transceiver module, for performing wireless transmission; and
a control unit, coupled to the microphone and the second wireless transceiver module, for transmitting the voice signal received by the microphone to the first wireless transceiver module via the second wireless transceiver module.

2. The telephone system of claim 1, wherein the communication content of the destination comprises a voice component, and the web phone module controls the signal processing module to output the voice component via the speaker.

3. The telephone system of claim 2, wherein the smart phone device further comprises a phone speaker, and the web phone module is utilized for transmitting the voice component to the second wireless transceiver module via the first wireless transceiver module, to output the voice component via the phone speaker.

4. The telephone system of claim 2, wherein the signal processing module is utilized for demonstrating a predefined image when the web phone module establishes the connection of IP phone with the destination.

5. The telephone system of claim 4, wherein the predefined image is a picture corresponding to the destination.

6. The telephone system of claim 1, wherein the communication content of the destination comprises an image component and a voice component.

7. The telephone system of claim 6, wherein the web phone module controls the signal processing module to output the image component via the monitor and output the voice component via the speaker, and the signal processing module applies a display method of picture in picture or a display method of picture on picture, to demonstrate the multimedia content and the image component simultaneously via the monitor.

8. The telephone system of claim 7, wherein the signal processing module applies a display method of picture and picture to demonstrate the multimedia content and the image component simultaneously via the monitor.

9. The telephone system of claim 6, wherein the smart phone device further comprises a phone speaker and a phone monitor, the web phone module is further utilized for transmitting the voice component and the image component to the second wireless transceiver module via the first wireless transceiver module, to output the voice component via the phone speaker and output the image component via the phone monitor.

10. The telephone system of claim 1, wherein the smart phone device comprises a lens, to generate an image signal.

11. The telephone system of claim 10, wherein the control unit is utilized for transmitting the image signal captured by the lens to the first wireless transceiver module via the second wireless transceiver module, and the web phone module is utilized for receiving the image signal from the first wireless transceiver module and transmitting the image signal to the destination.

12. The telephone system of claim 10, wherein the web phone module is utilized for demonstrating a content of the image signal via the monitor.

13. The telephone system of claim 1, wherein the TV set comprises a lens, for generate an image signal.

14. The telephone system of claim 13, wherein the web phone module is utilized for transmitting the image signal captured by the lens to the destination and demonstrating a content of the image signal via the monitor.

15. The telephone system of claim 1, wherein the smart phone device comprises a keyboard, for obtaining a telephone number, and transmits the telephone number to the first wireless transceiver module via the second wireless transceiver module, to establish the connection of IP phone via the web phone module.
